(19) United States
(12) Patent Application Publication
(10) Pub. No.: US 2004/0091614 A1
(43) Pub. Date: May 13, 2004

(54) Method for reusing powder coating

(75) Inventors: Koichi Sakai, Tokyo (JP); Kazuhiko Nakayama, Wakayama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nippon Paint Co., Ltd., Osaka (JP)

(21) Appl. No.: 10/290,151

(22) Filed: Nov. 8, 2002

(51) Int. Cl. B05D 1/12

(52) U.S. Cl. 427/180; 427/8

(57) ABSTRACT

A first toned paint which failed to adhere to a subject to be coated in a coating work is recovered, and a suitable amount of primary color paints are added to the recovered first toned paint to manufacture a second toned paint. This method includes a step of blending multiple types of primary color paints to manufacture the first toned paint (S5), and a step of memorizing a blending ratio or a composition ratio of the primary color paints in the first toned paint into a computer readable memory (S7). According to this invention, economy of a powder coating material is improved.

### BACKGROUND ART

1. Technical Field

The present invention relates to production of a powder coating material and a method of reusing the same.

2. Description of the Related Art

Conventionally, a powder coating material is widely used for coating of electric appliances such as a refrigerator or a microwave oven, or for coating of parts and the under floor of an automobile body, or for coating of furniture such as a desk or a locker.

A powder coating material is economically excellent in high adhesive efficiency over subjects to be coated, and also environmentally excellent as it does not contain an organic solvent.

In general, a powder coating material is manufactured as granulated fine powder consisting of 20 to 50-micrometer particulates by mixing and grinding a resin, a pigment, a curing agent, and an additive, etc.

When coating a subject to be coated using the powder coating material, a paint gun is used for spraying the powder coating material over the subject. (In this circumstance, coating particulates are electrostatically adhered to the subject). Subsequently, by heating with the coated subject, the sprayed powder coating material may be formed into a thin film and hardened. Thus the powder coating material is baked on the subject to be coated.

However, the aforementioned coating by use of a powder coating material causes a considerable quantity of the powder coating material to fall under the subject to be coated. The remaining paint or the residual paint was discarded without being used thereafter. The reason is that, even when added primary color paint with the aim of using the remaining paint for other color, the color of the remaining paint was difficult to change.

Therefore, a method of reusing a powder coating material capable of reusing the remaining powder coating material or residual powder coating material discarded as described above has been desired.

Incidentally, a powder coating material capable of presenting a desired color by carrying out mixed application of the powder coating material with primary colors is disclosed in JP-A-1998-212435 by the present applicant.

### SUMMARY OF THE INVENTION

The above-described problem is overcome by a method of reusing a powder coating material of this invention involving the below-mentioned steps.

A method of reusing a powder coating material in coating work which recovers a first toned paint which was not adhered to a subject to be coated, and adds a suitable amount of primary color paints so as to produce a second toned paint, comprising: a step of blending multiple types of primary color paints so that,first toned paint may be produced (S5); and a step of memorizing a blending ratio or a composition ratio of the primary color paints in the first toned paint (S7).

A composition ratio or blending ratio of each primary color paint of the first toned paint is preferably related with a name or ID of the first toned paint in the above situation and stored in a database.

By the above, when manufacturing a second toned paint, the composition ratio or blending ratio of a first toned paint can be identified easily.

Also, it is preferable that a sign or mark which relates with ID or the name of the first toned paint and specifies a physical storage position of the first toned paint is memorized.

A physical storage position of the first toned paint is thus easily identified.

A second aspect of this invention provides a method of reusing a powder coating material as described hereinafter.

A method of reusing a powder coating material, comprising: a step of blending multiple types of primary color paints and creating a first toned paint and at the same time memorizing a blending ratio or a composition ratio thereof; a step of conducting a coating work using the first toned paint; and a step of recovering and storing the first toned paint which failed to adhere to a subject to be coated in this coating work.

According to this invention, by reuse of a powder coating material, economical efficiency is enhanced.

### BRIEF DESCRIPTION OF THE DRAWINGS

FIG. 1 is a schematic explanatory view of a first embodiment of this invention.

FIG. 2 is a view showing a storing state such as blending data of a toned paint memorized into a computer-readable memory in the first embodiment.

FIG. 3 is a schematic explanatory view of a second embodiment of this invention.

FIG. 4 is a schematic explanatory view of a third embodiment.

### DESCRIPTION OF THE PREFERRED EMBODIMENTS

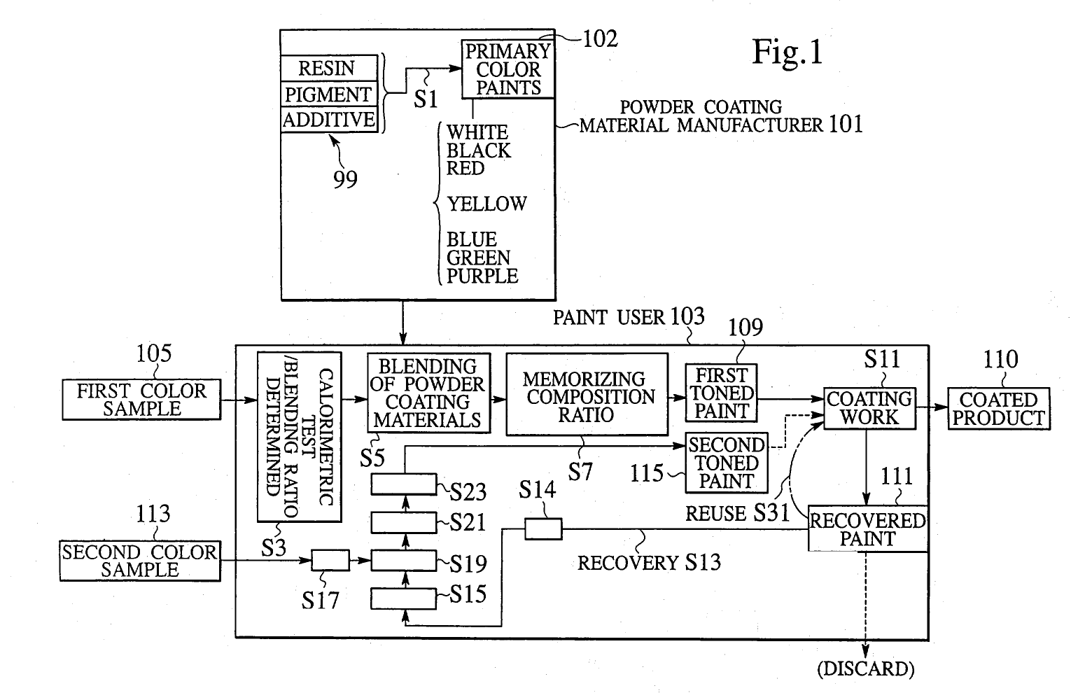

Preferred embodiment of the method of reusing a powder coating material of the invention will next be explained in conjunction with the drawings from FIG. 1 to FIG. 4.

### First Embodiment

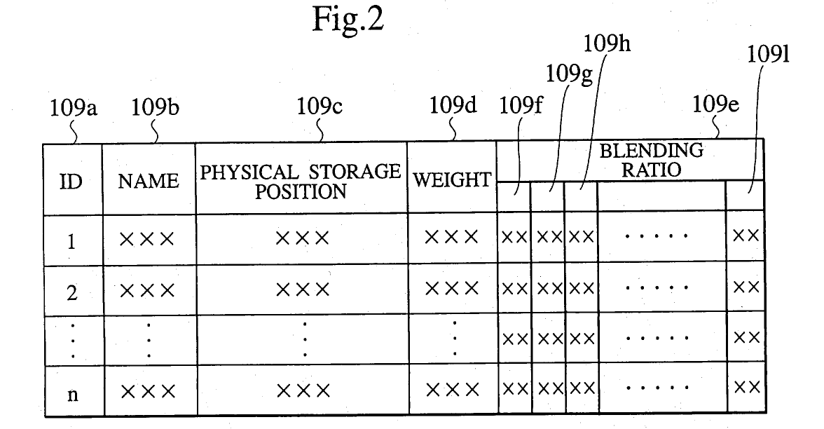

A first embodiment of this invention is explained in FIG. 1 and FIG. 2.

The first embodiment of this invention comprises:

a step of manufacturing a first toned paint by blending multiple types of primary color paints (S5);

a step of memorizing a blending or composition ratio of the toned paint into a computer readable memory (S7);

a step of conducting a coating work by use of the first toned paint (S11);

a step of recovering the first toned paint which failed to adhere to a subject to be coated in this paint work (S13); and

a step of adding a suitable amount of primary color paints to the recovered first toned paint to obtain a second toned paint (S23).

It is preferable that the above-described method is further includes following steps, comprising:

a step of comparing a blending ratio of primary color paints in a second toned paint and a blending ratio of each primary color paint in the first toned paint (S19);

a step of determining the quantity of primary color paints running short or the quantity of other recovered paint (S21); and

a step of adding the aforementioned primary color running short to the first toned paint (S23).

The above method is more specifically explained as in the following.

As shown in FIG. 1 and FIG. 2, the first embodiment of this invention is used in the institution consisting of a powder coating material manufacturer 101 and a paint user 103.

The powder coating material manufacturer 101 herein, manufactures primary color paints based on a resin, a pigment, and an additive in (and curing agent). More specifically, preliminary blending of the resin, pigment, and additive etc, 99 is carried out, followed by melt mixing, cooling, pulverization, and classification as needed, so that primary color paints 102 may be produced. The example shown in FIG. 1 reveals seven types of paints such as white, black, red, yellow, blue, green and purple manufactured as primary color paints.

Primary color paints 102 obtained from the paint manufacturer 101 is subjected to toning based on a first color sample 105 by the paint user 103, to produce a toned paint 109 of a desired color. The coating user 103 conducts coating the toned paint 109 over a subject to be coated to produce a coated product 110. As this coating product 110, for example electrical machinery products such as the aforementioned refrigerator or a microwave oven, a desk, or furniture such as a desk or a locker are mentioned.

A first embodiment of this invention performed in the institution of 101 and 103 will be explained as stated below.

As shown in FIG. 1, at the aforementioned powder coating material manufacturer 101, primary color paints 102 are manufactured based on the resin, pigment, and additive 99 (and curing agent) in a step of S1. Exemplary embodiment shown in FIG. 1 shows the primary color paints 102 consisting of seven types of colors such as white, black, red, yellow, blue, green, and purple. These primary colors are used as base color paints.

These primary color paints 102 are supplied to the paint user 103.

The paint user 103 receives a first color sample 105 from a customer (not shown). Then, the primary color paints 102 are subjected to blending and toning to achieve the color presented by this color sample 105 on a subject to be coated.

More specifically in a step of S3, a blending ratio of primary color paints 102 is determined by the operation as stated below.

First, a target color is subjected to colorimetric test beforehand to obtain a spectral-reflectance curve, followed by computation of the K/S value, which is a ratio of light absorption coefficient K to a scattering coefficient S. Subsequently, an isomeric match rucksack match is performed beforehand using the calculated reflectance factor computed from K/S values of n basic data obtained from the colorimetric test of powder coating materials of a multiple types of colors to be used. Subsequently the blending ratio of the powder coating materials of each color is computed by performing a metameric match using the result of this isomeric match and tristimulus values computed from the above calculated reflectance factor.

In a step of S5, primary colors (white, black, red, yellow, blue, green, and purple) obtained from the powder coating material manufacturers 101 are based on the result of the colormetric assay, and the color of the first color sample 105 as described above is reproduced. This paint subjected to blending and color matching is referred as a first toned paint 109 hereinafter.

In a step of S7, the blending proportion (blending ratio or composition ratio) of the primary color paints 102 in the first toned paint 109 is memorized into a computer readable memory as occasion demands.

As shown in FIG. 2, the blending ratio 109e of primary color paints in the first toned paint is related with ID 109a or the name 109b of the first toned paint and memorized into the memory. The blending ratio 109e is here given with a blending ratio of the primary color paints of white 109f, black 109g red 109h, . . . purple 109i.

In a step of S11, the first toned paint 109 is sprayed over a subject to be coated to obtain a coated product 110.

In this circumstance as described in the foregoing, a considerable amount of a powder coating material which failed to adhere to a subject to be coated is caused to fall in the back of the coating subject or under thereof. These powder coating materials are referred as remaining paint or recovered paint 111 hereinafter. As shown by dotted line in FIG. 1, these remaining paints or the recovered paint 111 was conventionally discarded.

In a step of S13, the remaining paint or the recovered paint 111 is collected.

Preferably, subsequently in a step of S14, colormetric test of the color on a subject to be coated of the recovered paint 111 is repeated so that the detected blending ratio for primary color paints may be related with the above-described ID and memorized into the memory (see FIG. 2). The reason of this colormetric re-test is that a blending ratio of the recovered paint may be different from that of the first toned paint before the coating work due to impurities etc. When such re-test is done, the detected blending ratio may be overwritten on 109e, or may be stored in a storage area prepared separately.

The above mentioned remaining paint or recovered paint 111 is weighed and stored in a predetermined physical storage position in a step of S15.

Also, as shown in FIG. 2, the sign or name which identifies the stored weight of 109d and storing position 109c is related with ID or the name of the first toned paint and memorized into the memory. Incidentally, in that case, use histories (a paint use date, a paint user name, a name of a subject to be coated, etc.) of the recovered paint 111 can be related with the above-described ID etc., and can also be memorized.

The remaining paint or the recovered paint 111 collected in this way is accumulated for subsequent reuse.

Then, a second color sample 113 is presented by a customer to a paint user 103.

In a step of S17, the paint user (or painter) 103 determines a blending ratio of primary color paints 102 by conducting a colormetry of the second color sample 113 with the colorimeter (CCM), so as to realize the color of the second color sample on a subject to be coated. This toned paint is referred as a second toned paint hereinafter. In addition, in a step of S17, the blending ratio of each primary color paint (namely, weight of each primary color paint) is also determined based on the required quantity of the second toned paint.

In a step of S19, a blending ratio determined in the step of S17 is compared with a blending ratio of each primary color paint in the recovered paint 111.

In a step of S21, the quantity of each primary color paint running short when manufacturing a second toned paint using the recovered paint 111 is determined.

In a step of S23, each primary color paint running short as described above is added to the recovered paint 111 to thereby produce a second toned paint 115.

Incidentally, a step of S23 can also be performed by the paint manufacturer 101 side. In this case, the numerical value and the recovered paint 111 which were determined in the step of S21 are sent to the paint manufacturer 101. Then in the paint manufacturer 101, the primary color paints 102 are added to the recovered paint 111, to thereby produce a second toned paint 115.

In addition, below-mentioned operations may also be included after a step of S23, as occasion demands. Namely, the color on a subject to be coated of a second toned paint produced in the step of S23 is verified whether it is fully in agreement with the color of the second color sample 113 by the naked eye or by such as a colorimeter. When not in agreement, primary color paints 102 presenting suitable color are further added by manual operation to produce a final second toned paint.

Incidentally, in this case as described above, a blending ratio of each primary color paint in a scheduled second toned paint (determined amount in a step of S17) and a blending ratio of each primary paint in the recovered paint 111 was compared in a step of S19. And in a step of S21, the amount of primary color paints running short when manufacturing the second toned paint was determined using the recovered paint 111, to thereby add the amount of the primary color paints running short to the recovered paint 111. In this case, based on the blending ratio of the primary color paints in the recovered paint 111 and the blending ratio of the primary color paints in the scheduled second toned paint, by adding the primary color paints gradually by manual operation, the second toned paint 115 can also be realized.

Incidentally, when using the recovered paint 111 with its blending ratio as it is, this can be used for a coating work as it is (step of S31).

### Second Embodiment

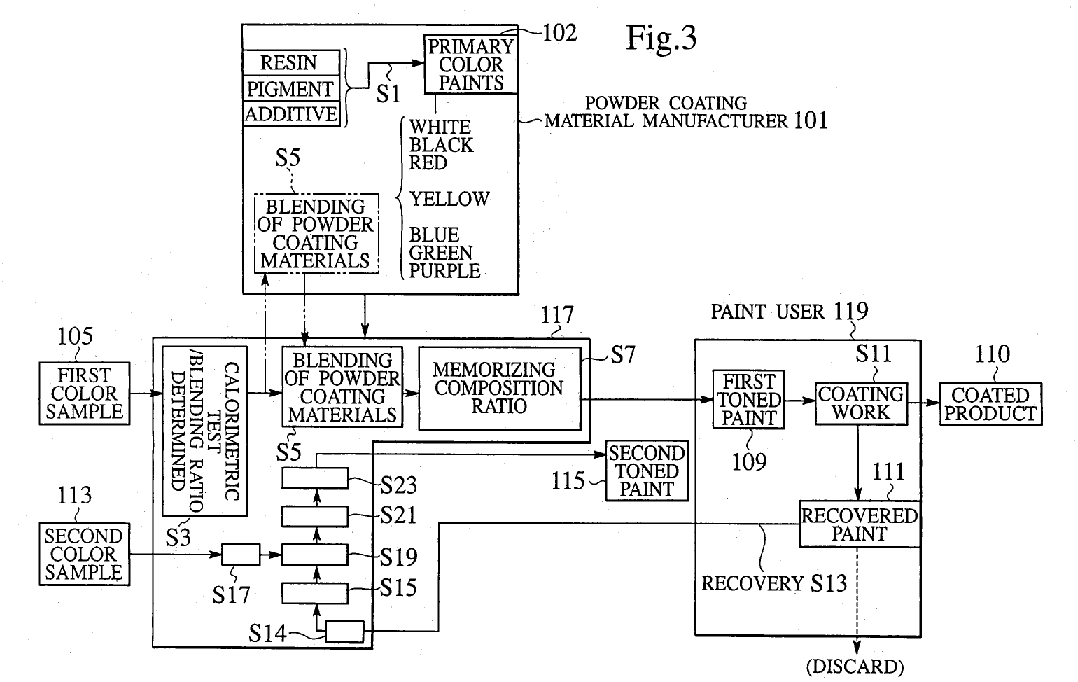

FIG. 3 is a view showing a second embodiment of a method of reusing a powder coating material of this invention.

The components and the step of the same designation as those in a first embodiment used for the explanation so far are designated the like numerals and signs, omitting the overlapping explanation.

Difference between this second embodiment and the first embodiment resides in that in the second embodiment, an agency 117 and a paint user 119 play the role of a paint user 103 in the first embodiment. This second embodiment is preferably adopted, in case of a small-scale manufacture which produces a comparatively little amount of coated product using a comparatively little amount of paint by a coating user 119.

More specifically in a first embodiment, the primary color paints 102 are supplied to a paint user 103 from the paint manufacture 101 directly, whereas in a second embodiment, the primary color paints 102 are supplied to an agency 117, and the agency 117 manufactures a toned paint 109 according to a color sample 105.

Incidentally, as shown by dotted line in FIG. 3, a step S5 (a step to blend powder coating materials to produce a first toned paint 109) can also be performed by the paint manufacturer 101. In this case, an agency 117 transmits a blending ratio obtained in a step of S3 via such as a communication circuit (not shown), so that primary color paints 102 may be blended by the paint manufacturer 101 based on this blending ratio to create the first toned paint 109. The finished first toned paint 109 is sent to the agency 117.

A toned paint 109 produced by the agency 117 is supplied to a paint user 119. Coating work over a subject to be coated by use of this toned paint 109 is performed by this paint user 119. Also, in this second embodiment, recovered paint 111 is returned to the agency 117 from the paint user 119 (S13). In this agency 117, the recovered paint 111 is stored along with a blending ratio thereof (S15). In addition, colorimetric test of the blending ratio of the recovered paint 111 is conducted again and the resulting blending ratio of the colorimetry can also be memorized into the memory.

After that, if a second color sample 113 is shown from other different paint user (not shown) from the paint user 119 for example, an agency 117 determines the blending ratio and blending amount of the primary color paints, to thereby realize the color of a color sample 113 on a subject to be coated, as well as doing the colorimetric test of this color sample 113 (S17).

Also, an agency 117 compares a blending ratio in the step of S17 with a blending ratio of the recovered paint (S19), and determines the amount of the primary color paints running short, so as to manufacture a second toned paint (S21) corresponding to the color sample 113 using the recovered paint.

Incidentally in that case, all of the recovered paint 111 is not necessarily used.

An agency 117 adds an insufficient quantity of the primary color paints determined in the step of S21 to the recovered paint 111, to produce a second toned paint 115 (step of S23). As stated before, this step of S23 can also be performed by a paint manufacturer 101. In this case, the recovered paint and the numeric value obtained in the step of S21 are transmitted to a manufacturer 101 from the agency 117.

In addition, the color of a toned paint on a subject to be coated manufactured in a step of 23 is compared with the second color sample and checked by naked eye or colorimeter. Then each primary color paint may be added as needed to manufacture a final second toned paint 115.

This second toned paint 115 which was subjected to color matching is supplied to other paint user different from the paint user 119.

In this second embodiment also, the agency 117 keeps the recovered paint 111 along with a blending ratio and blending weight thereof (blending data). And since a new toned paint (the second toned paint) is manufactured using the stored recovered paint when occasion demands later, effective use of powder coating materials is achieved to thereby protect earth environment.

Incidentally, if there is no opportunity of reuse or re-utilization thereof by the time when time-lapse change occurs in the stored recovered paint after the expiration of a considerable time, a gray paint can be prepared from recovered paint 111. This gray paint can be used for the various purposes such as an under coat.

### Third Embodiment

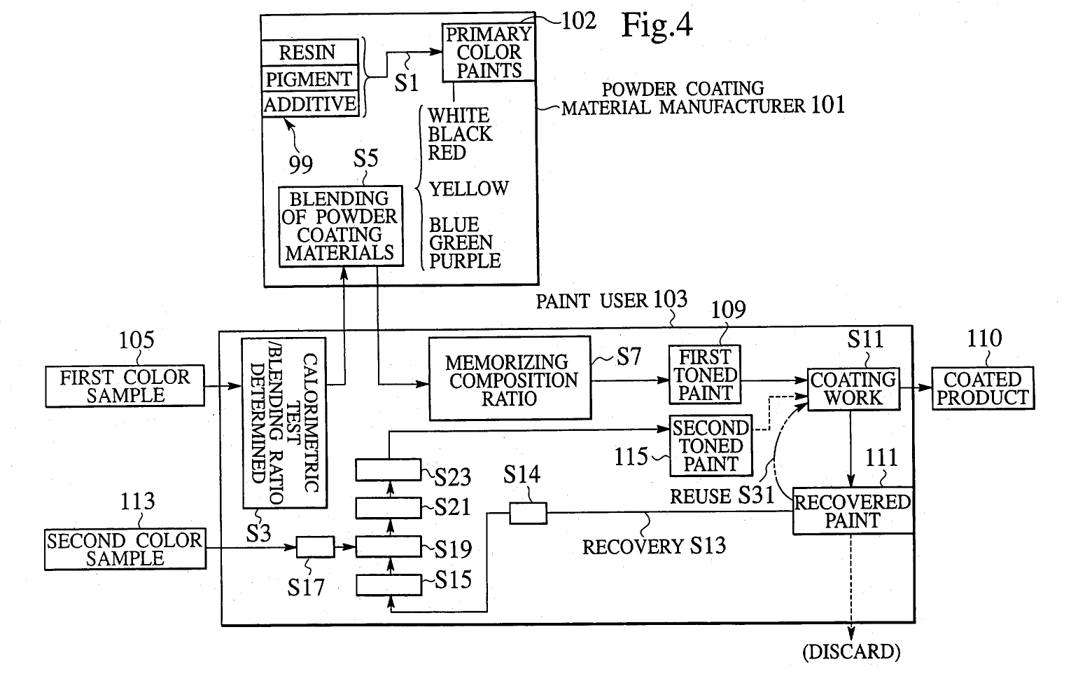

FIG. 4 is a view showing a third embodiment of this invention.

This embodiment is adapted such that a manufacturing step (S5) of the first toned paint in a first embodiment is performed by a paint manufacturer 101 side.

In this embodiment, a paint user 103 determines a blending ratio of a toned paint (S3), and this determined blending ratio is transmitted to a paint manufacturer 101 with an order via communication circuit (not shown). The paint manufacturer 101 blends a material paint 102 based on the blending ratio and create the first toned paint 109 (S5). Then the created first toned paint 109 is sent to the paint user 103. The complementary step is the same as that of the first embodiment to thereby omit and simplify the overlapping explanation.

Incidentally, as materials of a powder coating material of the first, the second, and the third embodiment, the materials indicated in JP-A-10-212435, for example can be used. The aforementioned JP-A-10-212435 is incorporated in this specification for reference.

This application shall be based on the Japan patent application issued previously, i.e., Japanese patent application No. 139249/2000 (filing date May 11, 2000) and shall incorporate these specifications here for reference.

What is claimed is

1. A method of reusing a powder coating material wherein a first toned paint which failed to adhere to a subject to be coated in a coating work is recovered, and a suitable amount of a primary color paint or other recovered paint is added to the recovered first toned paint, so as to produce a second toned paint, comprising:
a step of blending multiple types of primary color paints to manufacture the first toned paint (S5); and
a step of memorizing a blending ratio or composition ratio of the primary color paints in said first toned paint into a computer-readable memory (S7).

2. A method of reusing a powder coating material as claimed in claim 1, wherein a blending ratio or composition ratio of each primary color paint in said first toned paint is related with the name or ID of the first toned paint, and memorized in a computer-readable storage medium.

3. A method of reusing a powder coating material as claimed in claim 2, wherein in case of storing said first toned paint in a physical storage position, a sign or name are related with the name or ID of the first toned paint to specify the storing place, and memorized in said storage medium.

4. A method of reusing a powder coating material as claimed in claim 1, comprising a step of conducting a colorimetric test of the color intended to be realized by said second toned paint and determining a blending amount of each primary color paint in said second toned paint. (S17).

5. A method of reusing a powder coating material as claimed in claim 4, comprising:
a step of comparing a blending amount of each primary color paint in said second toned paint and a blending amount of each primary color paint in said recovered first toned paint (S19);
a step of determining a quantity of primary color paints running short, in case of manufacturing said second toned paint using said recovered first toned paint (S21); and
a step of adding said primary color paints running short to said recovered first toned paint (S23).

6. A method of reusing a powder coating materials, comprising:
a step of blending multiple types of primary color paints to create a first toned paint;
a step of memorizing a blending ratio or composition ratio of the primary color paints in said first toned paint;
a step of performing a coating work using said first toned paint; and
a step of recovering and storing a first toned paint which failed to adhere to a subject to be coated in this coating work.

7. A method of reusing a powder coating material, as claimed in claim 6, wherein in case of storing said first toned paint in a physical storage position, a mark or sign which specifies a storing position is related with the name or ID of the first toned paint and memorized into said storage medium.
